(19) United States
(12) Patent Application Publication
(10) Pub. No.: US 2023/0125379 A1
(43) Pub. Date: Apr. 27, 2023

(54) UNIVERSAL STEM SHAFT HANDLE

(71) Applicant: Stephen E. Finegan, JR., Hernando, FL (US)

(72) Inventor: Stephen E. Finegan, JR., Hernando, FL (US)

(21) Appl. No.: 17/860,057

(22) Filed: Jul. 7, 2022

Related U.S. Application Data
(62) Division of application No. 16/776,287, filed on Jan. 29, 2020.

(51) Int. Cl. F16K 31/60; G05G 1/08

(52) U.S. Cl. CPC F16K 31/60; G05G 1/08

(57) ABSTRACT

A stem shaft handle has a handle body and a geared ratchet assembly disposed within an inner cavity defined by the handle body. The threaded cylindrical drive head connects the geared ratchet assembly to a chuck assembly having a cylindrical chuck body concentrically disposed within an outer sleeve. The cylindrical chuck body has an outer surface which closely aligns with the outer sleeve in a key-and-lock style geometric alignment. The outer surface of the cylindrical chuck body has at least one biasing locking protuberance, and the outer sleeve defines adjacent notches around at least one nodule geometrically configured to operatively engage the at least one biasing locking protuberance in a locking arrangement. Upon a rotation of the stem shaft handle relative to the outer sleeve, the outer sleeve impinges the biasing locking protuberance until the biasing locking protuberance snaps into the locking arrangement.

### CROSS-REFERENCE TO RELATED APPLICATIONS

This application is a divisional continuation of co-pending and commonly owned U.S. application Ser. No. 16/776,287, filed on Jan. 29, 2020, the full disclosure of which is hereby incorporated herein by reference in its entirety and priority of which is hereby claimed.

### BACKGROUND OF THE INVENTION

### Field of the Invention

The present invention generally relates to stem shaft handles and more particularly relates to valve stem shaft handle devices which can be removably coupled to a stem shaft of universal size, configuration, and condition.

### Description of the Related Art

People around the world encounter broken handles of water valves, particularly exterior spigots used for hose connections, which typically have valves with relatively small diameter stem shafts having damaged splines which make it difficult for mating with conventional replacement handles. It is often difficult to find replacement valve handles that properly fit the varying sizes of the valve stem shafts. In addition to being small, typical valve handles are smooth and slippery when wet. As a result, they are difficult to grip adequately to open or close the valve. Since the valve handles are oftentimes located close to an obstruction, slippage can cause abrasion injuries to the operator's hand. These problems are especially difficult for people with reduced or impaired gripping strength, such as some of the elderly or people afflicted with arthritis or other debilitating conditions.

A variety of different types of handles are frequently employed in efforts to grasp and retain stem shafts.

Many such handle devices are not easily securable to damaged stem shafts of variable sizes. While these conventional units may be suitable for the particular purpose employed, they would not be as suitable for the purposes of the present invention as disclosed hereafter. None of such conventional devices disclose the unique structures and advantages of the present disclosure.

A need exists for valve handle devices that will help to more easily replace broken handles for valve stem shafts of nearly universal size and for damaged valve stem shafts, where the valve handles can better grasp various sizes of stem shafts as well as grasp damaged valve stem shafts.

A need exists for a valve handle device capable of universal application to valve stem shafts and splines of varying orientation and shape, and of varying thicknesses.

Accordingly, there is a need for a compact portable lightweight and strong valve handle apparatus for securely grasping and operatively rotating a valve stem shaft, which apparatus may be easily positioned and/or repositioned on the stem shaft at the option and intention of the user without complex assembly and setup.

As disclosed in this application, the inventor has discovered novel and unique devices and methods for securely grasping and operatively rotating a valve stem shaft of varying sizes and conditions, which exhibit superlative properties without being dependent on a particular spline configuration or difficult-to-find components.

The devices and methods disclosed herein avoid many of the drawbacks of existing methods and devices which rely on multiple tools and/or spline repair for application of the devices to the valve stem shaft.

Embodiments of the present invention provide for valve handle devices and methods as described and defined in the description below and in the annexed claims which provide for improved mobility, setup, and retention characteristics in order to efficiently grasp and engage valve stem shafts of various sizes, shapes, and conditions, in a multitude of environments.

Embodiments of the present invention also provide for ratchet handle devices and methods as described and defined in the description below and in the annexed claims which provide for improved mobility, setup, and retention characteristics in order to efficiently grasp, engage, and shafts of various sizes, shapes, and conditions, in a multitude of environments.

### SUMMARY OF THE INVENTION

It is one prospect of the present invention to provide a novel universal handle of simple and effective application which can be applied to varying sizes and shapes of stem shafts and splines and efficiently connected to securely grasp and retain stem shafts and splines of different sizes and shapes, including damaged stem shafts and splines, for various types of water spigots, air tanks, and gaseous tanks.

Further objects of the invention are to provide universal stem shaft handles which are comparatively simple and efficient in their application to stem shafts and their operation of the respective valve, while remaining readily removable at the option of a user. It is also an aim of the present invention to provide an improved ratchet handle system that provides improved ergonomic use and is of economical construction while providing nearly universal fit for intended shafts, overcoming the complexities and limitations of conventional ratchet tools.

Another object of the present invention is to provide a handle which allows quick adjustment of the positioning of the handle upon the intended stem shaft or spline by allowing easy adjustment by a user of the universally fitting handle.

Yet another object of the present invention is to provide a handle device wherein the handle is in the shape of a sign element containing a character and/or other visually appealing design elements thereon, and wherein the handle device is easily attached and detached from the shaft at the option of the user.

Additional objects, advantages and novel features of this invention shall be set forth in the description that follows, and in part will become apparent to those skilled in the art upon examination of the following specification. The objects and advantages of the invention may be realized and attained by means of the instrumentalities, combinations, and devices particularly pointed out in the appended claims.

The following presents a simplified summary of the present disclosure in a simplified form as a prelude to the more detailed description that is presented herein.

Therefore, to achieve the foregoing and other objects and in accordance with the purposes and embodiments of the present invention, as embodied and described herein, there is provided a stem shaft handle comprising a handle body adapted to be grasped by a hand of a user and a chuck assembly removably connected to the handle body. Preferably, the chuck assembly has a cylindrical chuck body concentrically disposed within an outer sleeve, and the cylindrical chuck body has an outer surface which closely aligns with the outer sleeve in a key-and-lock style geometric alignment. In a preferred embodiment, the cylindrical chuck body is fixed to the handle body.

In one embodiment, the outer surface of the cylindrical chuck body includes at least one biasing locking protuberance, and the outer sleeve defines at least one nodule that is geometrically configured to fittingly engage such biasing locking protuberance in a locking arrangement, such that upon rotation of the handle body relative to the outer sleeve, at least a portion of the outer sleeve impinges the biasing locking protuberance of the cylindrical chuck body (i.e., overcomes the biasing of the locking protuberance) until the biasing locking protuberance is rotated enough to surpass the impinging portion of the outer sleeve and hence snaps into the locking arrangement between the outer sleeve and the cylindrical chuck body.

In a preferred embodiment, the outer surface of the cylindrical chuck body includes at least two biasing locking protuberances, and the outer sleeve defines at least two nodules that are geometrically configured to fittingly engage the two biasing locking protuberances in a locking arrangement, such that upon rotation of the handle body relative to the outer sleeve, at least two portions of the outer sleeve respectively impinge the two biasing locking protuberances of the cylindrical chuck body (i.e., overcomes the biasing of the locking protuberances) until the biasing locking protuberances are rotated enough to surpass the respective impinging portions of the outer sleeve and hence snap into the locking arrangement between the outer sleeve and the cylindrical chuck body. In one embodiment, the at least two portions of the outer sleeve contemporaneously impinge the two biasing locking protuberances, respectively, of the cylindrical chuck body; in another embodiment, the at least two portions of the outer sleeve sequentially impinge the two biasing locking protuberances, respectively, of the cylindrical chuck body.

In one embodiment, the outer surface of the cylindrical chuck body of the stem shaft handle is fixed to the handle body with glue. In another embodiment, the outer surface of the cylindrical chuck body of the stem shaft handle is welded to the handle body.

In another embodiment, the cylindrical chuck body of the stem shaft handle comprises a plurality of jaws axially moveable to a constricted orientation adapted to grasp a stem shaft having varying diameters and axially moveable to an extended orientation adapted to release the stem shaft, such that rotation of the handle body in a first direction relative to the outer sleeve will radially constrict the jaws for grasping the stem shaft, and such that rotation of the handle body in a second (opposite) direction relative to the outer sleeve will radially extend the jaws for releasing the stem shaft. In such embodiment, the handle body of the stem shaft handle is adapted to rotate the grasped stem shaft clockwise or counterclockwise, at the option of the user, when in the locking arrangement.

In one embodiment, the stem shaft handle further includes a centrally disposed threaded bolt, the handle body defines an aperture sized to closely surround the threaded bolt, and the cylindrical chuck body defines a threaded opening adapted to receive the threaded bolt, such that the threaded bolt connects the handle body to the chuck assembly.

In a preferred embodiment, the chuck assembly of the stem shaft handle further includes an inner clamp guide that is rotatably disposed within the cylindrical chuck body and includes a plurality of jaws engagingly disposed in between the inner clamp guide and the cylindrical chuck body. In such embodiment, the inner clamp guide preferably has a top plate fixed to a top of the cylindrical chuck body. Preferably, the plurality of jaws have threaded exterior surfaces and respective interior surfaces, with an opening between the jaws adapted to removably clamp at least a portion of an outer surface of a stem shaft. The jaws are elevationally slidable against the inner clamp guide, such that the jaws are axially moveable to a constricted orientation for grasping the stem shaft and axially moveable to an extended orientation for releasing the stem shaft.

In one embodiment, the handle body of the stem shaft handle has walls extending perpendicularly from the handle body, such that the walls form an inner cavity, where at least a portion of the cylindrical chuck body is disposed within said inner cavity.

In another embodiment, the stem shaft handle includes a handle body that is molded in the shape of a football helmet. In another embodiment, the stem shaft handle has a handle body that is molded in the shape of a vehicle emblem, such as a Chevrolet® symbol. In yet another embodiment, the stem shaft handle has a handle body that is molded in the shape of a gecko. In a preferred embodiment, the handle body is molded in the shape of a frog.

In yet another embodiment of the invention is disclosed a stem shaft handle having a handle body adapted to be grasped by a hand of a user and a chuck assembly having a cylindrical chuck body disposed within an outer sleeve, where the cylindrical chuck body has an upper end that includes a concentrically disposed cylindrical plate that is removeably connected to the handle body; and the concentrically disposed cylindrical plate defines at least one nonconcentrically disposed aperture adapted to receive a retention member. Preferably, at least one nonconcentrically disposed retention member engages the concentrically disposed cylindrical plate of the chuck assembly in a lock and key style geometric alignment.

In one embodiment, the at least one nonconcentrically disposed retention member of the stem shaft handle is a molded protrusion extending from a bottom surface of the handle body, where such molded protrusion engages an aperture of with the concentrically disposed cylindrical plate and interlocks such cylindrical plate. In a preferred embodiment, the handle body of the stem shaft handle includes at least three nonconcentrically disposed retention members where each is a molded protrusion extending from a bottom surface of the handle body, and all of the at least three molded protrusions engage respective apertures of the concentrically disposed cylindrical plate and thus interlock the concentrically disposed cylindrical plate.

In yet another embodiment, the concentrically disposed cylindrical plate includes an at least one nonconcentrically disposed aperture that is internally threaded, and the at least one nonconcentrically disposed retention member of stem shaft handle is a threaded screw, which connects the handle body to the cylindrical plate of the chuck assembly.

In another embodiment, the stem shaft handle comprises at least one nonconcentrically disposed rivet, and the handle body defines at least one nonconcentrically disposed aperture sized to closely surround the at least one nonconcentrically disposed rivet; in such embodiment, the at least one nonconcentrically disposed aperture is adapted to receive the at least one nonconcentrically disposed rivet, such that the at least one nonconcentrically disposed rivet connects the handle body to the chuck assembly of the stem shaft handle.

In one embodiment, the handle body of the stem shaft handle body is connected to the concentrically disposed cylindrical plate with glue.

In yet another embodiment, the stem shaft handle includes a centrally disposed threaded bolt, and the handle body defines an aperture sized to closely surround the threaded bolt; in such embodiment, the cylindrical chuck body defines a threaded opening adapted to receive the threaded bolt, such that the threaded bolt connects the handle body to the chuck assembly.

In another embodiment, the stem shaft handle includes a centrally disposed fir tree fastener, and the handle body defines an aperture sized to closely surround and engage the centrally disposed fir tree fastener; in such embodiment, the cylindrical chuck body preferably defines an opening adapted to receive the centrally disposed fir tree fastener, and the centrally disposed fir tree fastener connects the handle body to the chuck assembly when the fir tree fastener extends through the handle body aperture and is inserted into the cylindrical chuck body aperture.

In one embodiment, the concentrically disposed cylindrical plate of the stem shaft handle comprises a ferrous material, and the handle body includes a magnet adapted to magnetically attach the handle body to the concentrically disposed cylindrical plate. Preferably, in such embodiment, the at least one nonconcentrically disposed retention member of the stem shaft handle is a molded protrusion extending from a bottom surface of the handle body, such that the at least one molded protrusion interlocks with the concentrically disposed cylindrical plate, while the concentrically disposed cylindrical plate is magnetically attached to the handle body.

In a preferred embodiment, the stem shaft handle includes a cylindrical chuck body having a three-jaw chuck which includes jaws axially moveable to a constricted orientation adapted to grasp a stem shaft having varying diameters and axially moveable to an extended orientation adapted to release the stem shaft; in such preferred embodiment, rotation of the handle body relative to the outer sleeve will radially constrict and extend the jaws for grasping and releasing the stem shaft, respectively.

In yet another embodiment, the stem shaft handle includes a cylindrical chuck body having a four-jaw independent chuck which includes jaws axially moveable to a constricted orientation adapted to grasp a stem shaft having varying diameters and axially moveable to an extended orientation adapted to release the stem shaft; in such embodiment, rotation of the handle body relative to the outer sleeve will radially constrict and extend the jaws for grasping and releasing the stem shaft, respectively.

In one embodiment disclosed herein, the cylindrical chuck body of the stem shaft handle comprises a drill chuck.

In a preferred embodiment, the cylindrical chuck body includes jaws having teeth formed on an inner surface of the jaws, which provides for improved gripping of the outer surface of a stem shaft when clamped thereupon.

In one embodiment, the cylindrical chuck body of the stem shaft handle comprises a collet chuck having a plurality of collet jaws axially moveable to a constricted orientation adapted to grasp a stem shaft having varying diameters and axially moveable to an extended orientation adapted to release the stem shaft; in such embodiment, rotation of the handle body relative to the outer sleeve will radially constrict and extend the plurality of collet jaws for grasping and releasing the stem shaft, respectively.

In a preferred embodiment, the handle body of the stem shaft handle is molded in the shape of a football helmet. In another embodiment, the handle body is molded in the shape of a gecko. In yet other embodiments, the handle body is molded in the shape of a toy car or in the shape of a vehicle emblem, such as a Chevrolet® symbol, Ford® symbol, or other publicly recognized symbols. Preferably, the handle body is molded in the shape of a frog or an elephant or other animal, adapted to be grasped by a hand of the user. In another preferred embodiment, the handle body is molded in the shape of a toy car. Upon a review of this present disclosure by Applicant, one of ordinary skill in the art could appreciate that the handle body could also be molded or take the shape of other additional characters, caricatures, toys, and emblems, each of which is adapted to be grasped by a hand of the user.

In another preferred embodiment, a stem shaft handle is provided comprising a handle body adapted to be grasped by a hand of a user and a geared ratchet assembly disposed within an inner cavity of the handle body. In such embodiment, the geared ratchet assembly includes a rotatable cylindrical anvil having an external surface comprising teeth, at least one pawl for operatively engaging said teeth, at least one pawl biasing member for biasing the at least one pawl, and a cam switch adapted to disengage said at least one pawl from said teeth at the option of the user. Preferably, a chuck assembly is fixedly connected to the geared ratchet assembly, and the chuck assembly includes a cylindrical chuck body concentrically disposed within an outer sleeve. The cylindrical chuck body has an upper end fixedly connected to the geared ratchet assembly and has an outer surface which closely aligns with the outer sleeve in a key-and-lock style geometric alignment. Preferably, the outer surface of the cylindrical chuck body has at least one biasing locking protuberance, and the outer sleeve defines at least one nodule geometrically configured to fittingly engage the at least one biasing locking protuberance in a locking arrangement, such that upon rotation of the handle body relative to the outer sleeve, at least a portion of the outer sleeve impinges the at least one biasing locking protuberance of the cylindrical chuck body until said biasing locking protuberance snaps into the locking arrangement between the outer sleeve and the cylindrical chuck body.

In one embodiment, the geared ratchet assembly of the stem shaft handle further includes a threaded cylindrical drive head, and the cylindrical chuck body defines a central threaded opening adapted to receive the threaded cylindrical drive head, such that the threaded cylindrical drive head connects the geared ratchet assembly to the chuck assembly.

Preferably, the upper end of the cylindrical chuck body comprises a concentrically disposed cylindrical plate, and the cylindrical anvil of the geared ratchet assembly is concentrically molded upon a top surface of the concentrically disposed cylindrical plate of the stem shaft handle.

In one embodiment, the at least one pawl of the stem shaft handle operatively engages the teeth of the cylindrical anvil in a first position, such that the at least one pawl restricts movement of the geared ratchet assembly in a counterclockwise direction.

In one embodiment, the at least one pawl of the stem shaft handle operatively engages the teeth of the cylindrical handle in a second position such that the at least one pawl restricts movement of the geared ratchet assembly in a counterclockwise direction and a counterclockwise direction, locking movement of the handle body relative to the chuck assembly.

In one embodiment, the at least one pawl of the stem shaft handle operatively engages the teeth of the cylindrical anvil in a third position such that the at least one pawl restricts movement of the geared ratchet assembly in a clockwise direction.

Preferably, the cylindrical chuck body comprises a three jaw chuck having jaws axially moveable to a constricted orientation adapted to grasp a stem shaft having varying diameters and axially moveable to an extended orientation adapted to release the stem shaft, such that rotation of the handle body relative to the outer sleeve will radially constrict and extend the three jaws for grasping and releasing the stem shaft, respectively.

In another embodiment, the cylindrical chuck body of the stem shaft handle comprises a four-jaw independent chuck having jaws axially moveable to a constricted orientation adapted to grasp a stem shaft having varying diameters and axially moveable to an extended orientation adapted to release the stem shaft, such that rotation of the handle body relative to the outer sleeve will radially constrict and extend the four jaws for grasping and releasing the stem shaft respectively.

In yet another embodiment, the cylindrical chuck body of the stem shaft handle comprises a drill chuck.

In one embodiment, the cylindrical chuck body of the stem shaft handle comprises a plurality of jaws axially moveable to a constricted orientation adapted to grasp a stem shaft having varying diameters and axially moveable to an extended orientation adapted to release the stem shaft, such that rotation of the handle body relative to the outer sleeve will radially constrict and extend the jaws for grasping and releasing the stem shaft, respectively.

Preferably, jaws of the stem shaft handle have teeth formed on an inner surface of the jaws, to provide improved grasp of the intended valve stem shaft.

Preferably, the handle body of the stem shaft handle is molded in the shape of a football helmet, a gecko, a vehicle emblem, such as a such as a Chevrolet® symbol, or a frog, either of which is adapted to be grasped by a hand of the user.

In yet another embodiment of the invention, a stem shaft handle is disclosed having a gearless ratchet. Preferably, the stem shaft handle has a handle body adapted to be grasped by a hand of a user. In such preferred embodiment, the handle body defines an inner cavity having an inside surface. A gearless ratchet assembly is disposed within the inner cavity of the handle body and is bidirectionally rotatable therein. The gearless ratchet assembly includes a threaded cylindrical drive head. The stem shaft handle includes a chuck assembly having a cylindrical chuck body defining a central threaded opening adapted to receive the threaded cylindrical drive head. The threaded cylindrical drive head connects the gearless ratchet assembly to the chuck assembly. In such embodiment, the cylindrical chuck body is concentrically disposed within an outer sleeve and the cylindrical chuck body has an outer surface which closely aligns with the outer sleeve in a key-and-lock style geometric alignment. The outer surface of the cylindrical chuck body has at least one biasing locking protuberance and the outer sleeve defines at least one nodule, which is geometrically configured to fittingly engage the at least one biasing locking protuberance in a locking arrangement. In such embodiment, the at least one nodule fittingly engages the at least one biasing locking protuberance such that upon rotation of the handle relative to the outer sleeve, at least a portion of the outer sleeve impinges the biasing locking protuberance of the cylindrical chuck body until the biasing locking protuberance snaps into the locking arrangement between the outer sleeve and the cylindrical chuck body.

In one embodiment, the cylindrical chuck body comprises a three-jaw chuck having jaws which are axially moveable to a constricted orientation and adapted to grasp a stem shaft having varying diameters. The jaws are also axially moveable to an extended orientation adapted to release the stem shaft. In such embodiment, rotation of the handle body relative to the outer sleeve will radially constrict and extend the jaws for grasping and releasing the stem shaft respectively.

In another embodiment, the cylindrical chuck body comprises a four jaw independent chuck having jaws which are axially moveable to a constricted orientation and adapted to grasp a stem shaft having varying diameters. The jaws are also axially moveable to an extended orientation and adapted to release the stem shaft. In such embodiment, rotation of the handle body relative to the outer sleeve will radially constrict and extend the jaws for grasping and releasing the stem shaft respectively.

In yet another embodiment, the cylindrical chuck body comprises a drill chuck.

In one embodiment, the cylindrical chuck body comprises a plurality of jaws which are axially moveable to a constricted orientation and adapted to grasp a stem shaft having varying diameters. The jaws are also axially moveable to an extended orientation and adapted to release the stem shaft. In such embodiment, rotation of the handle body relative to the outer sleeve will radially constrict and extend the jaws for grasping and releasing the stem shaft respectively.

In another embodiment, the jaws have teeth formed on the inner surface of the jaws.

In yet another embodiment, the stem shaft handle includes a handle body that is molded in the shape of a football helmet. In another embodiment, the stem shaft handle has a handle body that is molded in the shape of a vehicle emblem, such as a Chevrolet® symbol. In yet another embodiment, the stem shaft handle has a handle body that is molded in the shape of a gecko. In a preferred embodiment, the handle body is molded in the shape of a frog.

These and other features, aspects, and advantages of the present invention will become better understood with reference to the following description and appended claims.

### BRIEF DESCRIPTION OF THE DRAWINGS

Illustrative embodiments of the present invention are described herein with reference to the accompanying drawings, in which:

FIG. 1 is a front left perspective view of an exemplary stem shaft handle, in accordance with embodiments of the invention;

FIG. 2 is an exploded front right perspective view thereof;

FIG. 3 is a front perspective view of an exemplary cylindrical chuck body, in accordance with embodiments of the invention;

FIG. 4 is a top perspective view of an exemplary outer sleeve showing a nodule, in accordance with embodiments of the invention;

FIG. 5 is a top perspective partially exploded view of an exemplary cylindrical chuck body and an exemplary outer sleeve, in accordance with embodiments of the invention;

FIG. 6 is a front partial cutaway cross-sectional view of an exemplary stem shaft handle, in accordance with embodiments of the invention;

FIG. 7 is a bottom perspective view of an exemplary stem shaft handle in operation while connected to an exemplary stem shaft, in accordance with embodiments of the invention;

FIG. 8 is a bottom perspective view of an exemplary handle body, in accordance with embodiments of the invention;

FIG. 9 is an elevation view in partial cutaway of an exemplary stem shaft handle with an exemplary handle body, in accordance with embodiments of the invention;

FIG. 10 is an elevation view of an exemplary stem shaft handle with an exemplary handle body, in accordance with embodiments of the invention;

FIG. 11 is a top left perspective view of an exemplary cylindrical chuck body disposed within an exemplary outer sleeve, in accordance with embodiments of the invention;

FIG. 12 is a bottom left perspective view of an exemplary handle body in locking arrangement with an exemplary cylindrical chuck body, in accordance with embodiments of the invention;

FIG. 13 is a front elevation partially exploded view of an exemplary stem shaft handle showing an exemplary fir tree fastener, in accordance with embodiments of the invention;

FIG. 14 is a top front right perspective view of an exemplary cylindrical chuck body disposed within an exemplary outer sleeve showing a drill chuck, in accordance with embodiments of the invention;

FIG. 15 is a bottom partially perspective view of an exemplary cylindrical chuck body, in accordance with embodiments of the invention;

FIG. 16 is a front elevation partial cutaway cross-sectional view of an exemplary stem shaft handle showing an exemplary collet chuck, in accordance with embodiments of the invention;

FIG. 17 is a front elevation partial cutaway cross-sectional view cross-sectional view of an exemplary stem shaft handle showing an exemplary geared ratchet assembly, in accordance with embodiments of the invention;

FIG. 18 is a bottom perspective view of an exemplary handle body showing an exemplary geared ratchet assembly, in accordance with embodiments of the invention;

FIG. 19 is a bottom perspective view of an exemplary handle body showing exemplary pawls for engagement with a geared ratchet assembly, in accordance with embodiments of the invention;

FIG. 20 is a partially exploded view of an exemplary cylindrical chuck body showing an exemplary rotatable cylindrical anvil concentrically molded upon a top surface of a concentrically disposed cylindrical plate, in accordance with embodiments of the invention;

FIG. 21 is a front elevation view in partial cutaway cross section of an exemplary stem shaft handle showing a gearless ratchet assembly, in accordance with embodiments of the invention; and

FIG. 22 is a front bottom perspective view of an exemplary gearless ratchet assembly, in accordance with embodiments of the invention.

### DETAILED DESCRIPTION

For a further understanding of the nature and function of the embodiments, reference should be made to the following detailed description. Detailed descriptions of the embodiments are provided herein, as well as, the best mode of carrying out and employing the present invention. It will be readily appreciated that the embodiments are well adapted to carry out and obtain the ends and features mentioned as well as those inherent herein. It is to be understood, however, that the present invention may be embodied in various forms. Therefore, persons of ordinary skill in the art will realize that the following disclosure is illustrative only and not in any way limiting, as the specific details disclosed herein provide a basis for the claims and a representative basis for teaching to employ the present invention in virtually any appropriately detailed system, structure or manner. It should be understood that the devices, materials, methods, procedures, and techniques described herein are presently representative of various embodiments. Other embodiments of the disclosure will readily suggest themselves to such skilled persons having the benefit of this disclosure.

For purposes of clarity and orientation with respect to a person, referred to herein as a user, it is noted that a transverse (also known as axial or horizontal) plane is an X-Z plane, parallel to the ground. A frontal plane is a Y-X plane, perpendicular to the ground. A sagittal (also known as lateral) plane is a Y-Z plane, perpendicular to the ground, which separates left from right. Objects are coplanar if they all lie in the same plane. For example, one axis is coplanar with another axis when the two axes lie in the same plane.

As used herein, “axis” means a real or imaginary straight line about which a three-dimensional body is symmetrical. A “vertical axis” means an axis perpendicular to the ground (or put another way, an axis extending upwardly and downwardly). A “horizontal axis” means an axis parallel to the ground.

As used herein, homogeneous is defined as the same in all locations, and a homogeneous material is a material of uniform composition throughout that cannot be mechanically separated into different materials. Examples of “homogeneous materials” are certain types of plastics, ceramics, glass, metals, alloys, paper, board, resins, and coatings.

Reference will now be made in detail to the present preferred embodiments of the invention, examples of which are illustrated in the accompanying drawings. Wherever possible, the same reference numerals are used in the drawings and the description to refer to the same or like parts.

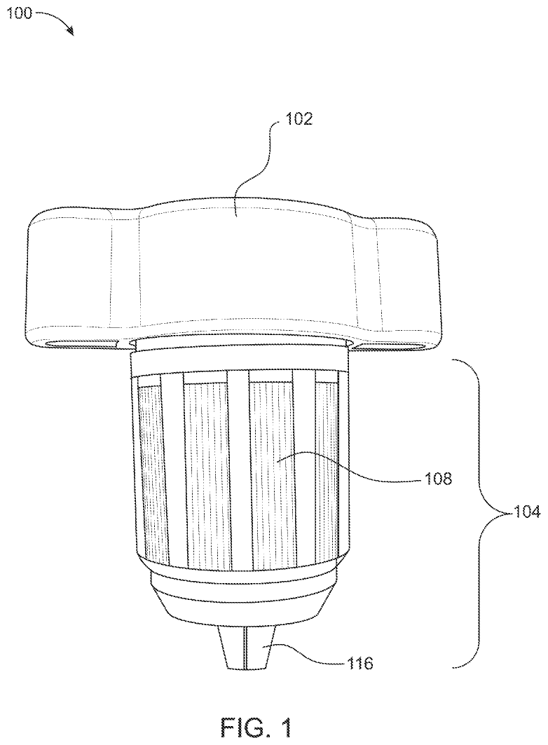

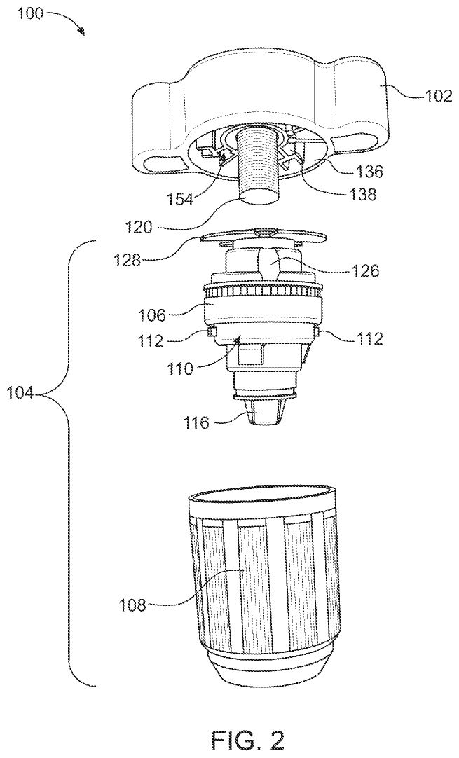

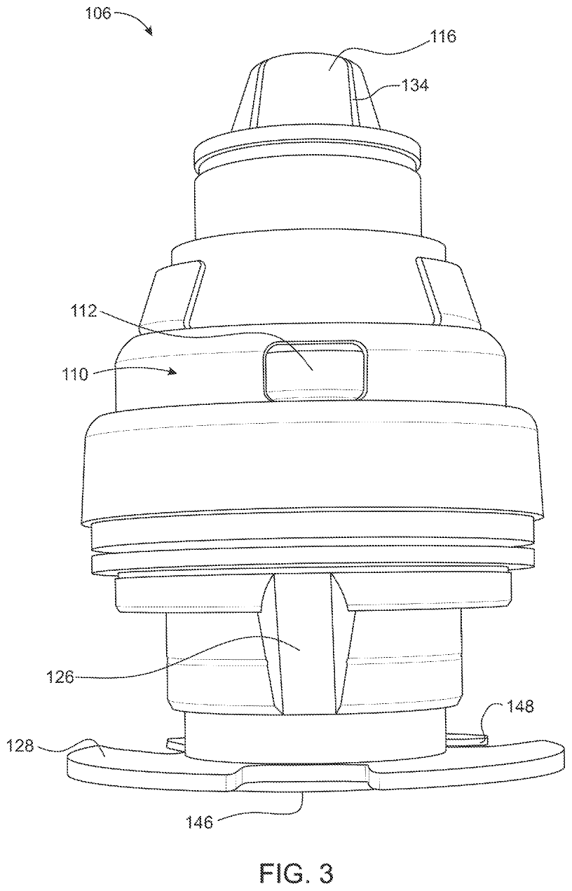

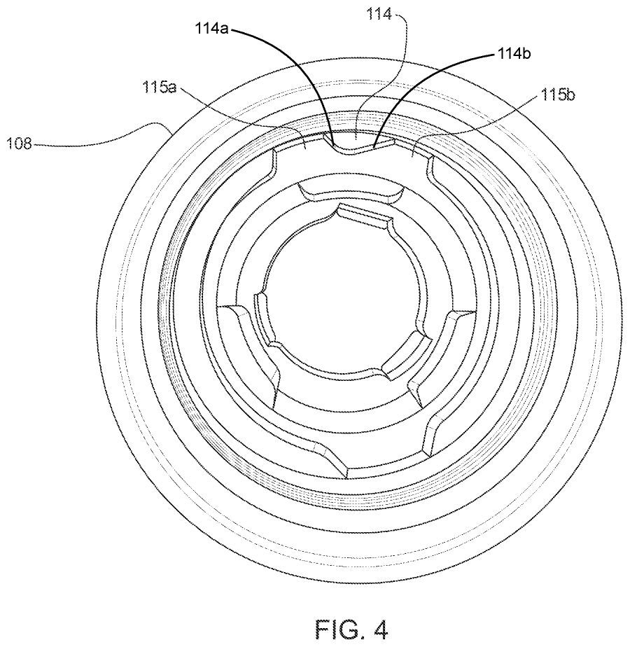

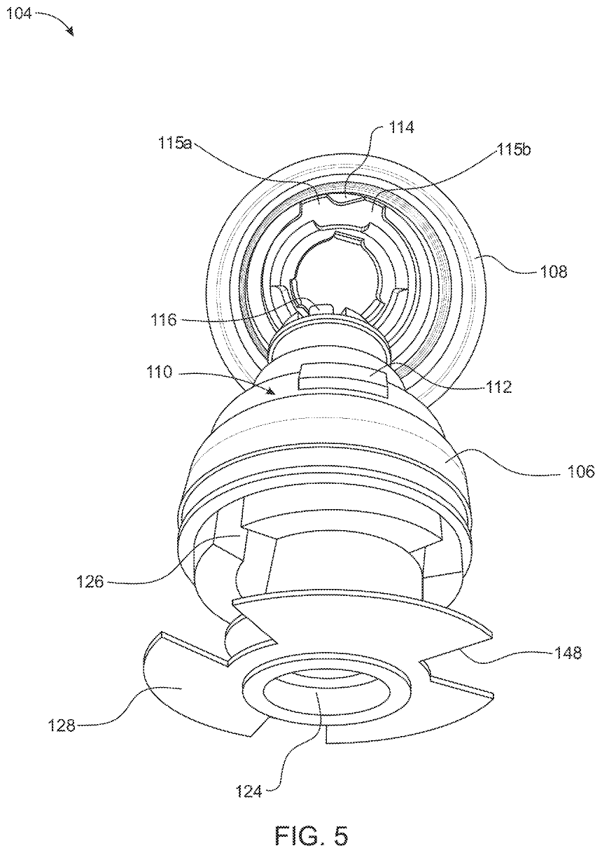

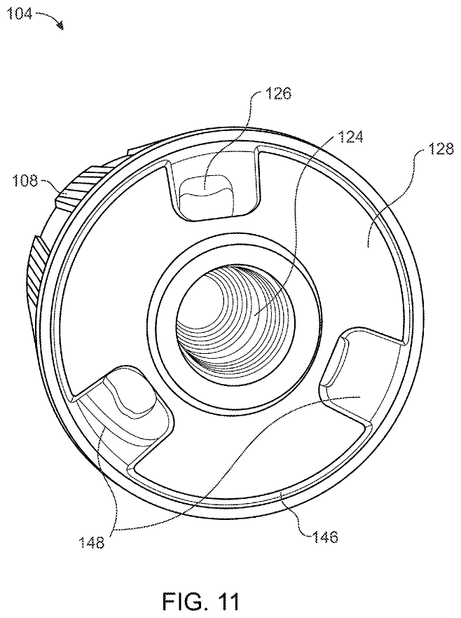

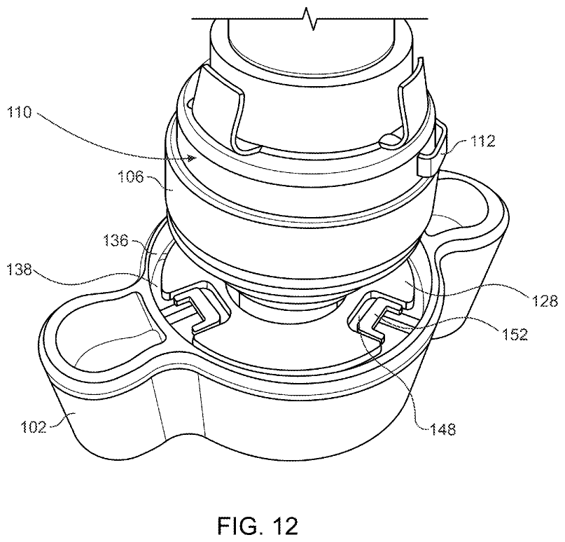

Referring initially to FIGS. 1-15, the basic constructional details and principles of operation of one embodiment of a stem shaft handle 100 according to a preferred embodiment of the present invention will be discussed. As shown in FIGS. 1 and 2, the stem shaft handle 100 preferably has a handle body 102 adapted to be grasped by a hand of a user, and the stem shaft handle 100 includes a chuck assembly 104 removably connected to the handle body 102. The chuck assembly 104 has a cylindrical chuck body 106 concentrically disposed within an outer sleeve 108, as shown in FIGS. 3-5. The cylindrical chuck body 106 has an outer surface 110 which closely aligns with the outer sleeve 108 in a key-and-lock style geometric alignment, as illustrated in FIGS. 5 and 11, wherein the cylindrical chuck body 106 is fixed to the handle body 102, as shown in FIG. 12. The outer surface 110 of the cylindrical chuck body 106 has at least one biasing locking protuberance 112, as illustrated in FIGS. 3, 5, and 12. The outer sleeve 108 forms at least one nodule 114 disposed between two notches 115a, 115b defined by the outer sleeve 108, as shown in FIGS. 4 and 5, geometrically configured to fittingly engage the at least one biasing locking protuberance 112 in a locking arrangement. Preferably the nodule 114 includes a first ramped portion 114a opposite a second ramped portion 114b, where the first ramped portion 114a is more inclined than the second ramped portion 114b relative to the respective adjacent notches 115a, 115b; in such embodiment, the first ramped portion 114a provides more resistance against impinging passage of the at least one biasing locking protuberance 112 than the second ramped portion 114b, when the cylindrical chuck body 106 is rotated relative to the outer sleeve 108. As illustrated in FIG. 5, the at least one nodule 114 engages the at least one biasing locking protuberance 112 such that upon rotation of the handle body 102 (and respective cylindrical chuck body 106) relative to the outer sleeve 108, at least a portion of the outer sleeve 108 impinges the at least one biasing locking protuberance 112 of the cylindrical chuck body 106 until said at least one biasing locking protuberance 112 snaps into the locking arrangement between the outer sleeve 108 and the cylindrical chuck body 106.

In one embodiment, the outer surface 110 of the cylindrical chuck body 106 is fixed to the handle body 102 with glue.

As illustrated in FIGS. 3, 6, 7, 9, 10, 13, and 15, the cylindrical chuck body 106 comprises a plurality of jaws 116 axially moveable to a constricted orientation adapted to grasp a stem shaft 118 having varying diameters and the plurality of jaws 116 are axially moveable to an extended orientation adapted to release the stem shaft 118, whereby rotation of the handle body 102 relative to the outer sleeve 108 will radially constrict and extend the plurality of jaws 116 for grasping and releasing the stem shaft 118 respectively. It will be apparent to those skilled in the art that the stem shaft handle 100 can be utilized, for example, to grasp a shaft of a screw or a lag bolt with a stripped or broken head.

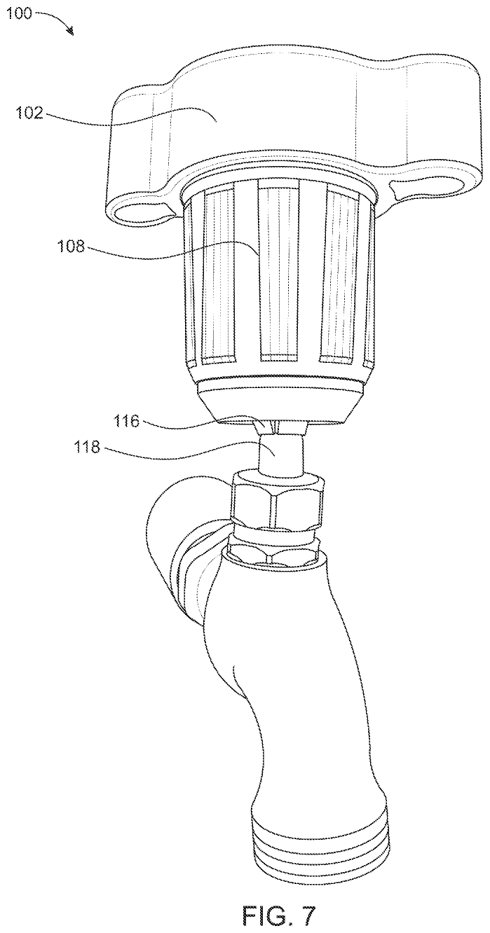

In yet another embodiment, when in the locking arrangement, the handle body 102 is adapted to rotate the stem shaft 118 clockwise or counterclockwise at the option of the user, as shown in FIG. 7.

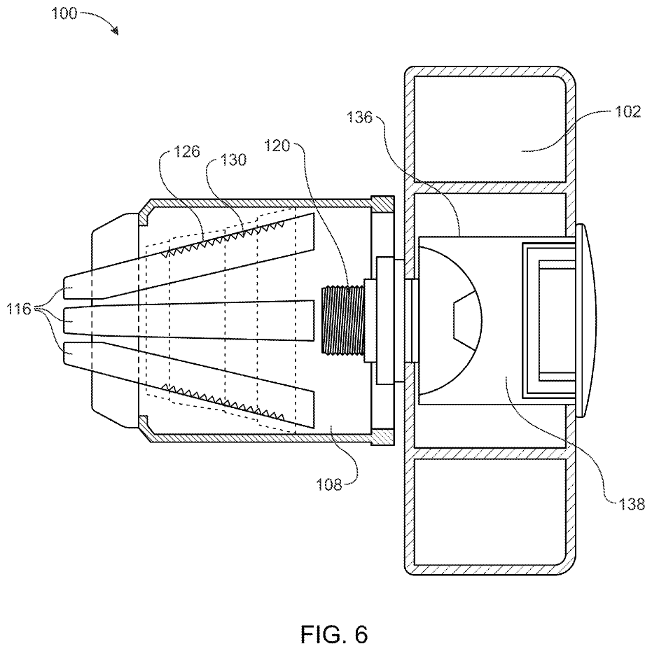

In one embodiment, the stem shaft handle 100 further comprises a centrally disposed threaded bolt 120, as illustrated in FIGS. 2, 6, and 8. The handle body 102 defines an aperture 122 sized to closely surround the threaded bolt 120, and the cylindrical chuck body 106 defines a threaded opening 124 adapted to receive the threaded bolt 120. The threaded bolt 120 connects the handle body 102 to the chuck assembly 104, as shown in FIG. 6.

Referring to FIGS. 5, 6, and 11, in another embodiment, the chuck assembly 104 further includes an inner clamp guide 126 rotatably disposed within the cylindrical chuck body 106 and a plurality of jaws 116 engagingly disposed between the inner clamp guide 126 and the cylindrical chuck body 106. The inner clamp guide 126 has a top plate 128 fixed to the cylindrical chuck body 106.

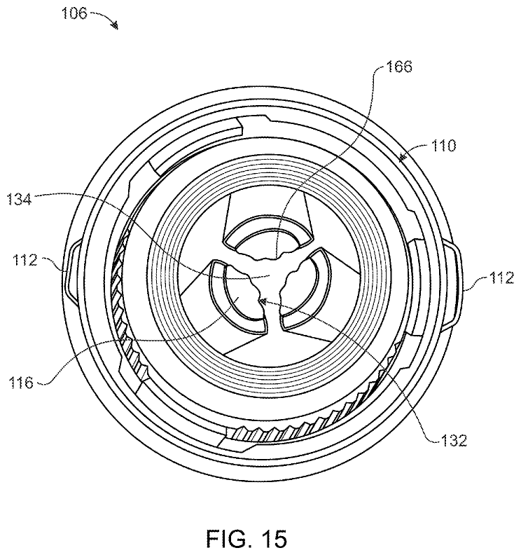

Referring to FIGS. 6 and 15, the plurality of jaws 116 comprise respective threaded exterior surfaces 130 that respectively engage inner threaded surfaces of the inner clamp guide 126. The plurality of jaws 116 surround an opening 134 and have respective interior surfaces 132 adapted to removably clamp onto at least a portion of an outer surface of a stem shaft 118, as exemplified in FIG. 7. The plurality of jaws 116 are elevationally slidable against the inner clamp guide 126. The plurality of jaws 116 are axially moveable to a constricted orientation for grasping the stem shaft 118, and the plurality of jaws 116 are axially moveable to an extended orientation for releasing the stem shaft 118.

In one embodiment, the handle body 102 has walls 136 extending perpendicularly from the handle body 102, and the walls 136 form an inner cavity 138, as shown in FIGS. 2, 6, 8 and 12. At least a portion of the cylindrical chuck body 106 is disposed within the inner cavity 138, as illustrated in FIGS. 2, 6 and 12.

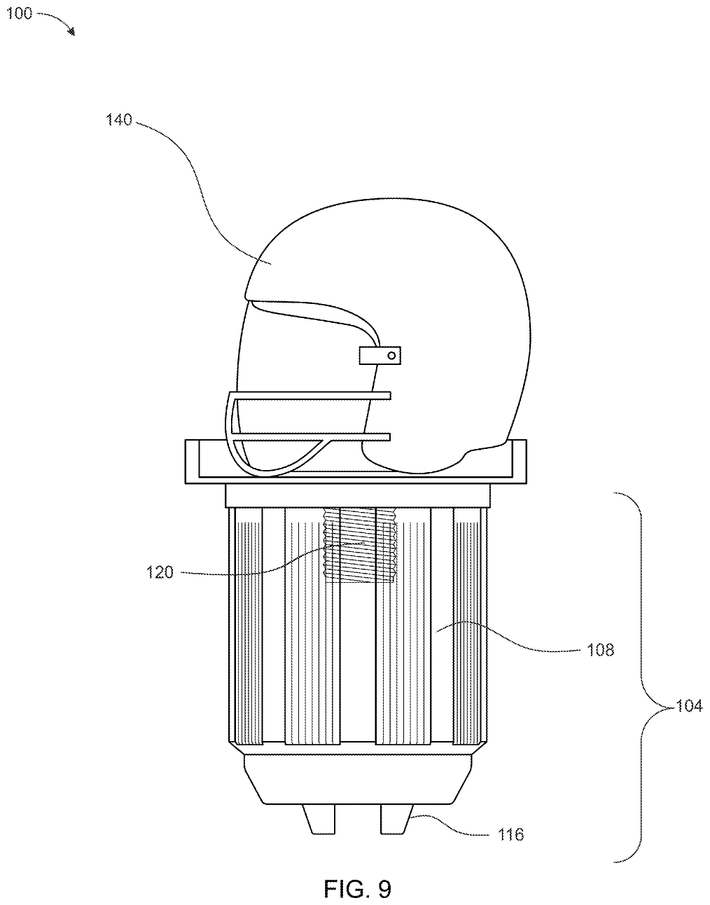

In another embodiment, as illustrated in FIG. 9, the handle body 102 is molded in the shape of a football helmet 140.

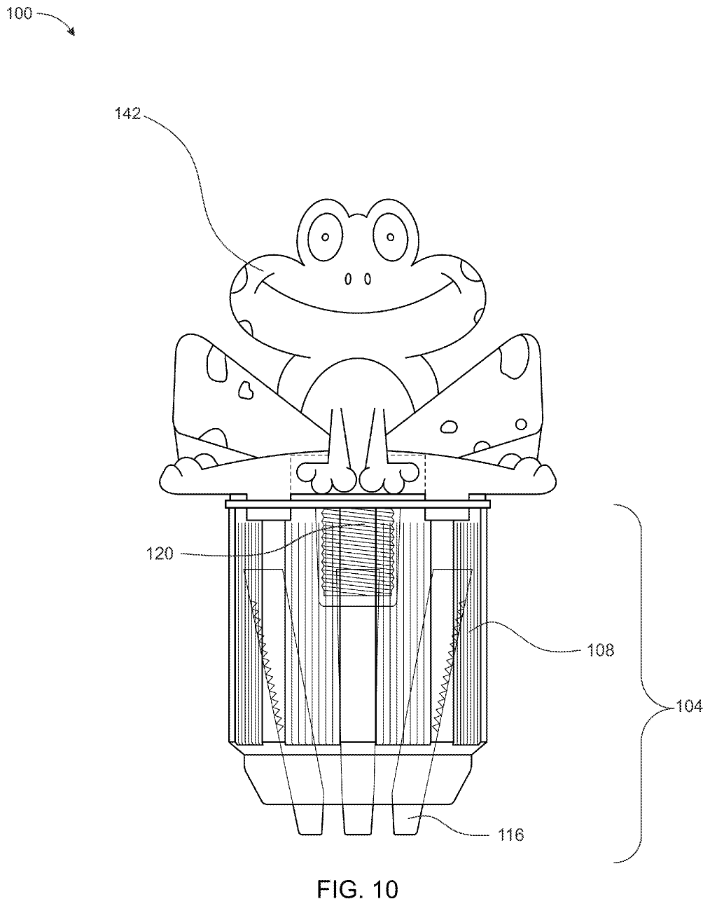

In yet another embodiment, as illustrated in FIG. 10, the handle body 102 is molded in the shape of a frog 142.

In another embodiment, the handle body 102 is molded in the shape of a gecko.

In yet another embodiment, the handle body 102 is molded in the shape of a vehicle emblem, such as a Chevrolet® symbol. Upon reviewing the disclosure herein, it will be apparent to those skilled in the art that the handle body 102 of the stem shaft handle 100 can be formed as variety of different designs such as animals, characters, shapes, or symbols.

Referring to FIGS. 1-16, the basic constructional details and principles of operation of additional preferred embodiments of a stem shaft handle 100 of the invention will be discussed.

Referring to FIGS. 3, 5, 11, and 12, the cylindrical chuck body 106 has an upper end 146 comprising a concentrically disposed cylindrical plate 128 removeably connected to the handle body 102, as illustrated in FIGS. 3 and 11. The concentrically disposed cylindrical plate 128 defines at least one nonconcentrically disposed aperture 148 adapted to receive a retention member and at least one nonconcentrically disposed retention member 150 engaging the concentrically disposed cylindrical plate 128 of the chuck assembly 104 in a lock and key style geometric alignment. As illustrated in FIG. 1, the stem shaft handle 100 has a handle body 102 adapted to be grasped by a hand of a user. The stem shaft handle 100 includes a chuck assembly 104, which has a cylindrical chuck body 106, which has an axial throughbore extending therethrough, disposed within an outer sleeve 108, as shown in FIG. 2.

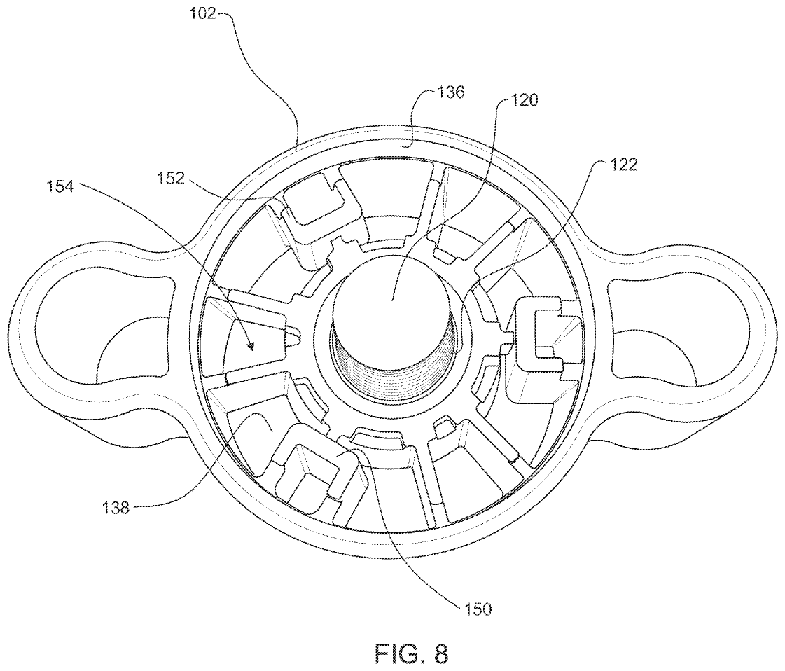

In one embodiment, as illustrated in FIGS. 8 and 12, the at least one nonconcentrically disposed retention member 150 is a molded protrusion extending from a bottom surface 154 of the handle body 102. The molded protrusion 152 interlocks with the concentrically disposed cylindrical plate 128, as seen in FIG. 12.

In another embodiment, the at least one nonconcentrically disposed retention member 150 of the stem shaft handle 100 can be constructed as a nonconcentrically disposed rivet, wherein the handle body 102 defines at least one nonconcentrically disposed aperture 148 sized to closely surround the nonconcentrically disposed rivet. In such embodiment, the at least one nonconcentrically disposed aperture 148 is adapted to receive the nonconcentrically disposed rivet, and the nonconcentrically disposed rivet connects the handle body 102 to the chuck assembly 104.

In yet another embodiment, the at least one nonconcentrically disposed aperture 148 is internally threaded and the at least one nonconcentrically disposed retention member 150 is a threaded screw. In such embodiment, the threaded screw connects the handle body 102 to the chuck assembly 104.

In another embodiment, the handle body 102 is connected to the concentrically disposed cylindrical plate 128 with glue.

In yet another embodiment, as shown in FIGS. 2, 6, and 8, the stem shaft handle 100 further includes a centrally disposed threaded bolt 120. The handle body 102 defines an aperture 122 sized to closely surround the threaded bolt 120. As illustrated in FIGS. 5 and 11, the cylindrical chuck body 106 defines a threaded opening 124 adapted to receive the threaded bolt 120. The threaded bolt 120 connects the handle body 102 to the chuck assembly 104.

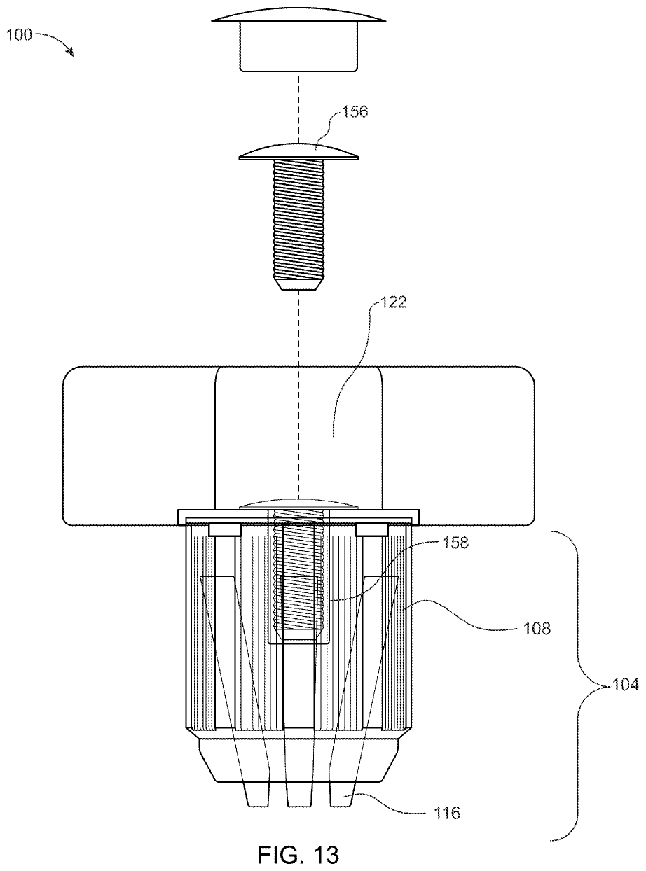

Referring to FIG. 13, in one embodiment, the stem shaft handle 100 further includes a centrally disposed fir tree fastener 156. The handle body 102 defines an aperture 122 sized to closely surround the centrally disposed fir tree fastener 156. The cylindrical chuck body 106 defines an opening 158 adapted to receive the centrally disposed fir tree fastener 156, and the centrally disposed fir tree fastener 156 connects the handle body 102 to the chuck assembly 104.

In another embodiment, the concentrically disposed cylindrical plate 128 comprises a ferrous material.

In yet another embodiment, the handle body 102 has a magnet adapted to magnetically attach the handle body 102 to the concentrically disposed cylindrical plate 128. Preferably, in such embodiment, the at least one nonconcentrically disposed retention member 150 of the stem shaft handle 100 is a molded protrusion 152 extending from a bottom surface 154 of the handle body 102, such that the at least one molded protrusion 152 interlocks with the concentrically disposed cylindrical plate 128, while the concentrically disposed cylindrical plate 128 is magnetically attached to the handle body 102, as illustrated in FIGS. 8, 11 and 12.

In one embodiment, as illustrated in FIG. 6, the cylindrical chuck body 106 comprises a three-jaw chuck 162 comprising jaws 116 axially moveable to a constricted orientation adapted to grasp a stem shaft 118 having varying diameters and axially moveable to an extended orientation adapted to release the stem shaft 118. Rotation of the handle body 102 in a first direction relative to the outer sleeve 108 will radially constrict the jaws 116 for grasping the stem shaft 118, and rotation of the handle body 102 in a second (opposite) direction relative to the outer sleeve 108 will radially extend the jaws 116 for releasing the stem shaft 118.

In another embodiment, the cylindrical chuck body 106 comprises a four jaw independent chuck comprising jaws 116 axially moveable to a constricted orientation adapted to grasp a stem shaft 118 having varying diameters and axially moveable to an extended orientation adapted to release the stem shaft 118. Rotation of the handle body 102 in a first direction relative to the outer sleeve 108 will radially constrict the jaws 116 for grasping the stem shaft 118, and rotation of the handle body 102 in a second (opposite) direction relative to the outer sleeve 108 will radially extend the jaws 116 for releasing the stem shaft 118.

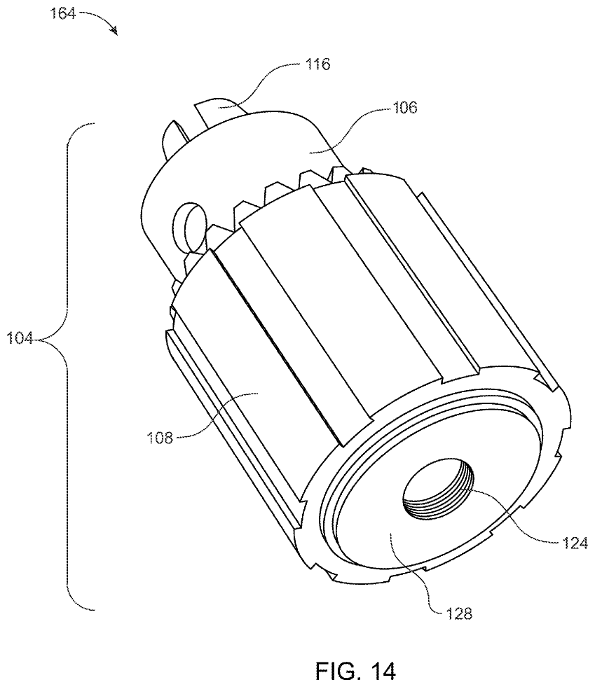

In yet another embodiment, the cylindrical chuck body 106 comprises a drill chuck 164, as illustrated in FIG. 14.

Preferably, the cylindrical chuck body 106 comprises jaws 116 having teeth 166 formed on an inner surface 132 of the jaws 116, as shown in FIG. 15.

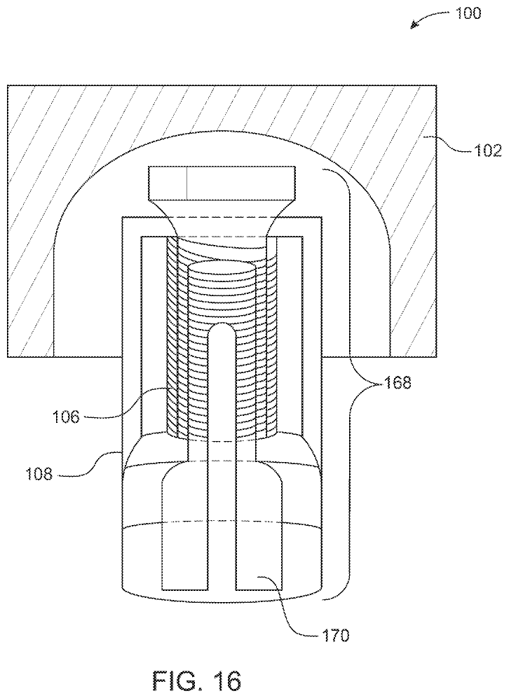

In another embodiment, as illustrated in FIG. 16, the cylindrical chuck body 106 comprises a collet chuck 168 having a plurality of collet jaws 170 axially moveable to a constricted orientation adapted to grasp a stem shaft 118 having varying diameters and axially moveable to an extended orientation adapted to release the stem shaft 118. Rotation of the handle body 102 relative to the outer sleeve 108 will radially constrict and extend the plurality of collet jaws 170 for grasping and releasing the stem shaft 118 respectively.

In one embodiment, as illustrated in FIG. 9, the handle body 102 is molded in the shape of a football helmet 140.

In another embodiment, as illustrated in FIG. 10, the handle body 102 is molded in the shape of a frog 142.

In yet another embodiment, the handle body 102 is molded in the shape of a gecko.

In yet another embodiment, the handle body 102 is molded in the shape of a vehicle emblem, such as a Chevrolet® symbol. Upon reviewing the disclosure herein, it will be apparent to those skilled in the art that the handle body 102 of the stem shaft handle 100 can be formed as variety of different designs such as animals, characters, shapes, or symbols.

Referring to FIGS. 1-20, the basic constructional details and principles of operation of preferred embodiments of a stem shaft handle 100 having a geared ratchet assembly 172 of the invention will be discussed.

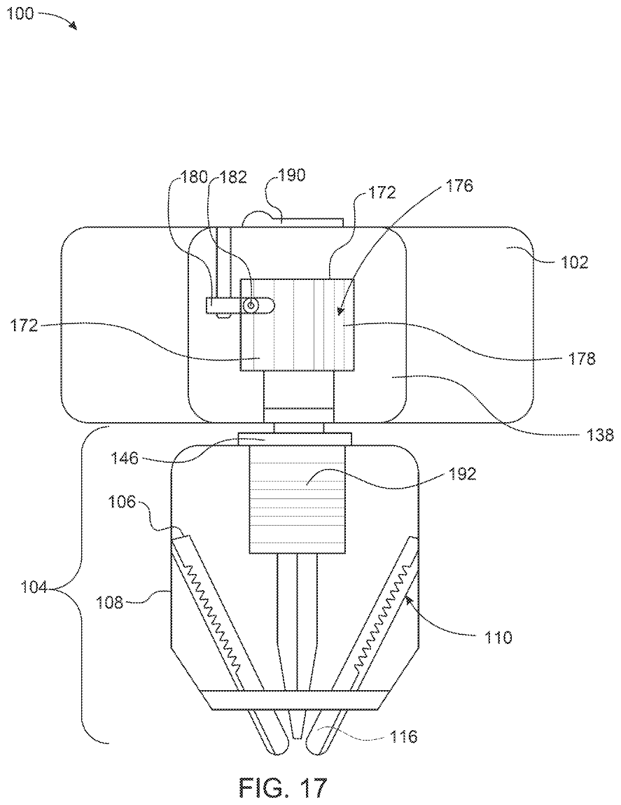

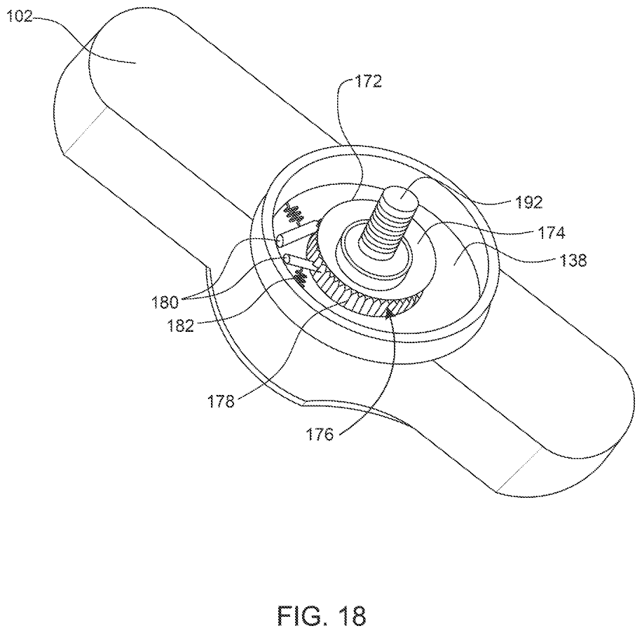

As illustrated in FIGS. 1 and 17, the stem shaft handle 100 has a handle body 102 adapted to be grasped by a hand of a user. The handle body 102 defines an inner cavity 138. The geared ratchet assembly 172 is disposed within the inner cavity 138 of the handle body 102, as illustrated in FIGS. 17-18. The geared ratchet assembly 172 has a rotatable cylindrical anvil 174, which has an external surface 176 comprising teeth 178, as shown in FIGS. 17, 18, and 20. The geared ratchet assembly 172 further includes at least one pawl 180 for operatively engaging the teeth 178 of the rotatable cylindrical anvil 174 and at least one pawl biasing member 182 for biasing the at least one pawl 180, as illustrated in FIGS. 17-19. A cam switch 190 located on the handle body 102 is adapted to disengage the at least one pawl 180 from the teeth 178 at the option of the user. The cam switch 190 is also adapted to switch the direction of the at least one pawl 180, which operatively engages the teeth 178 to provide for substantially unidirectional movement of the rotatable cylindrical anvil 174, at the option of the user. As illustrated in FIG. 17, the stem shaft handle 100 includes a chuck assembly 104 fixedly connected to the geared ratchet assembly 172. Preferably, the chuck assembly 104 has a cylindrical chuck body 106 concentrically disposed within an outer sleeve 108, as illustrated in FIGS. 5, 11, and 17. The cylindrical chuck body 106 has an upper end 146 fixedly connected to the geared ratchet assembly 172 and has an outer surface 110 which closely aligns with the outer sleeve 108 in a key-and-lock style geometric alignment. In such preferred embodiment, the outer surface 110 of the cylindrical chuck body 106 has at least one biasing locking protuberance 112, as shown in FIG. 3. The outer sleeve 108 comprises at least one nodule 114 geometrically configured to fittingly engage the at least one biasing locking protuberance 112 in a locking arrangement, as illustrated in FIGS. 4-5. Upon rotation of the handle body 102 (and respective cylindrical chuck body 106 attached thereto), relative to the outer sleeve 108, at least a portion of the outer sleeve 108 impinges and overcomes the bias of the at least one biasing locking protuberance 112 of the cylindrical chuck body 106 until the at least one biasing locking protuberance 112 snaps into the locking arrangement between the outer sleeve 108 and the cylindrical chuck body 106.

In one embodiment, the geared ratchet assembly 172 further includes a threaded cylindrical drive head 192, as illustrated in FIG. 18. In such embodiment, the cylindrical chuck body 106 defines a central threaded opening 124 adapted to receive the threaded cylindrical drive head 192, as illustrated in FIGS. 5, 11 and 14. The threaded cylindrical drive head 192 connects the geared ratchet assembly 172 to the chuck assembly 104.

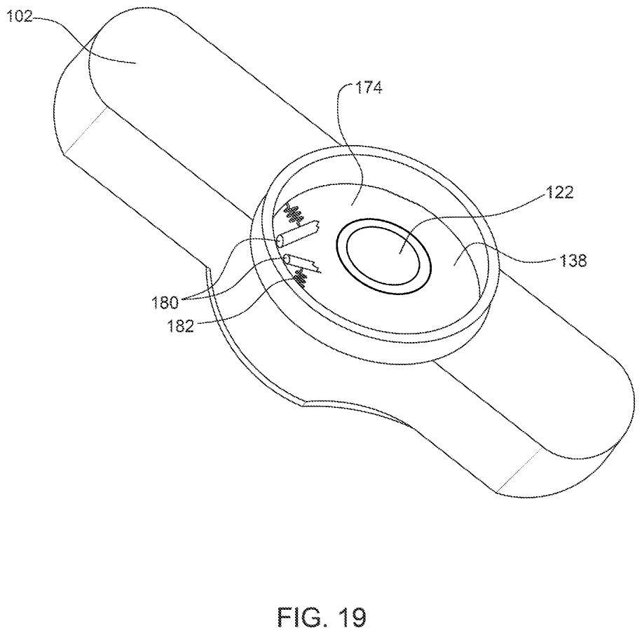

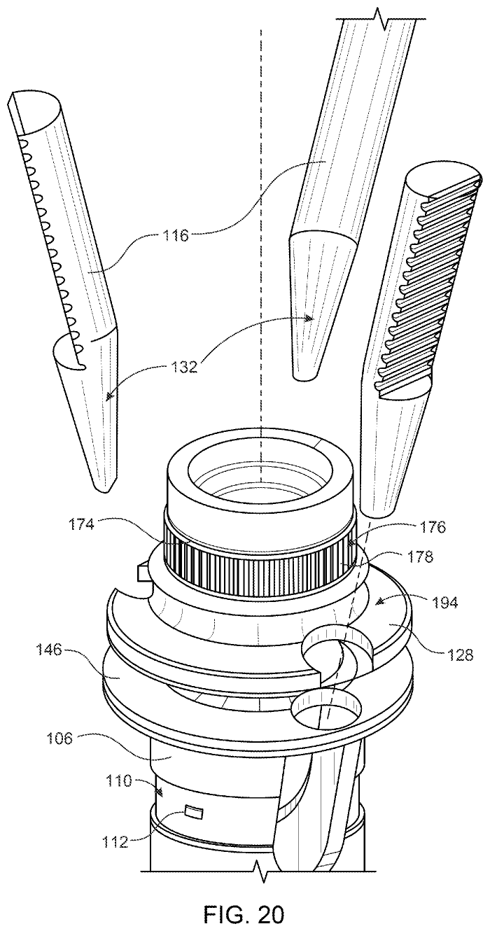

In another embodiment, the upper end 146 of the cylindrical chuck body 106 has a concentrically disposed cylindrical plate 128. In such embodiment, the cylindrical anvil 174 of the geared ratchet assembly 172 is concentrically molded upon a top surface 194 of the concentrically disposed cylindrical plate 128, as illustrated in FIGS. 19-20.

Referring to FIGS. 17-20, when the at least one pawl 180 operatively engages the teeth 178 in a first position, the at least one pawl 180 restricts movement of the geared ratchet assembly 172 in a counterclockwise direction.

In another embodiment, when the at least one pawl 180 operatively engages the teeth 178 in a second position, the at least one pawl 180 restricts movement of the geared ratchet assembly 172 in a counterclockwise direction and a clockwise direction, locking movement of the handle body 102 relative to the chuck assembly 104.

In yet another embodiment, when the at least one pawl 180 operatively engages the teeth 178 in a third position the at least one pawl 180 restricts movement of the geared ratchet assembly 172 in a clockwise direction.

In one embodiment, the stem shaft handle 100 which has the geared ratchet assembly 172 comprises a three-jaw chuck 162 comprising jaws 116 axially moveable to a constricted orientation adapted to grasp a stem shaft 118 having varying diameters and axially moveable to an extended orientation adapted to release the stem shaft 118, as illustrated in FIG. 6. In such embodiment, rotation of the handle body 102 relative to the outer sleeve 108 will radially constrict and extend the jaws 116 for grasping and releasing the stem shaft 118 respectively.

In another embodiment, the stem shaft handle 100 which has the geared ratchet assembly 172 comprises a four-jaw independent chuck comprising jaws 116 axially moveable to a constricted orientation adapted to grasp a stem shaft 118 having varying diameters and axially moveable to an extended orientation adapted to release the stem shaft 118. In such embodiment, rotation of the handle body 102 relative to the outer sleeve 108 will radially constrict and extend the jaws 116 for grasping and releasing the stem shaft 118 respectively.

In yet another embodiment, as illustrated in FIG. 14, the stem shaft handle 100 which has the geared ratchet assembly 172 comprises a drill chuck 164.

In one embodiment, the stem shaft handle 100 which has the geared ratchet assembly 172 comprises a plurality of jaws 116 axially moveable to a constricted orientation adapted to grasp a stem shaft 118 having varying diameters and axially moveable to an extended orientation adapted to release the stem shaft 118, as illustrated in FIG. 7. In such embodiment, rotation of the handle body 102 relative to the outer sleeve 108 will radially constrict and extend the jaws 116 for grasping and releasing the stem shaft 118 respectively.

In another embodiment, the jaws 116 comprise teeth 166 formed on an inner surface 132 of the jaws 116, as illustrated in FIG. 15.

In one embodiment, the handle body 102 is molded in the shape of a football helmet 140, as illustrated in FIG. 9.

In another embodiment, the handle body 102 is molded in the shape of a frog 142, as illustrated in FIG. 10.

In yet another embodiment, the handle body 102 is molded in the shape of a gecko.

In another embodiment, the handle body 102 is molded in the shape of a vehicle emblem, such as a Chevrolet® symbol. Upon reviewing the disclosure herein, it will be apparent to those skilled in the art that the handle body 102 of the stem shaft handle 100 can be formed as variety of different designs such as animals, characters, shapes, or symbols.

Referring to FIGS. 1-16 and 21-22, the basic constructional details and principles of operation of preferred embodiments of a stem shaft handle 100 having a gearless ratchet assembly 198 of the invention will be discussed.

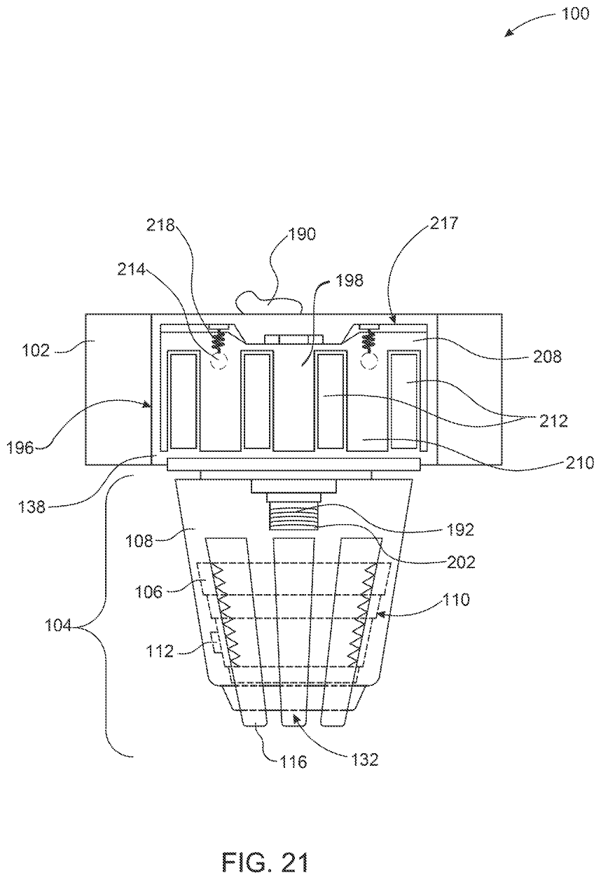

The stem shaft handle 100 comprises the gearless ratchet assembly 198 and includes a handle body 102 adapted to be grasped by a hand of a user. The handle body 102 defines an inner cavity 138 having an inside surface 196, as illustrated in FIGS. 8 and 21. The gearless ratchet assembly 198 is disposed within the inner cavity 138 of the handle body 102 and is bidirectionally rotatable therein, as illustrated in FIG. 21. In such preferred embodiment, the gearless ratchet assembly 198 comprises a threaded cylindrical drive head 192. The stem shaft handle 100 includes a chuck assembly 104 having a cylindrical chuck body 106 defining a central threaded opening 124 adapted to receive the threaded cylindrical drive head 192, as illustrated in FIGS. 5, 11, and 20. The threaded cylindrical drive head 192 connects the gearless ratchet assembly 198 to the chuck assembly 104. The cylindrical chuck body 106 is concentrically disposed within an outer sleeve 108 and the cylindrical chuck body 106 has an outer surface 110 which closely aligns with the outer sleeve 108 in a key-and-lock style geometric alignment, as illustrated in FIGS. 3-5 and 11. The outer surface 110 of the cylindrical chuck body 106 has at least one biasing locking protuberance 112, as illustrated in FIG. 3. The outer sleeve 108 defines at least one nodule 114 geometrically configured to fittingly engage the at least one biasing locking protuberance 112 in a locking arrangement, as illustrated in FIG. 4. The at least one nodule 114 engages the at least one biasing locking protuberance 112 such that upon rotation of the handle body 102, relative to the outer sleeve 108, at least a portion of the outer sleeve 108 impinges the biasing locking protuberance 112 of the cylindrical chuck body 106 until the biasing locking protuberance 112 snaps into the locking arrangement between the outer sleeve 108 and the cylindrical chuck body 106, as illustrated in FIG. 5.

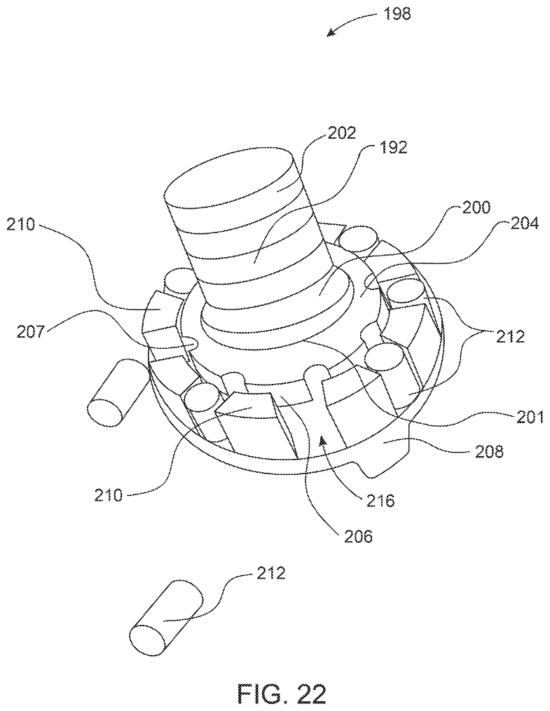

As illustrated in an exemplary embodiment of the invention shown in FIGS. 21 and 22, the gearless ratchet assembly 198 includes, for example, a sprag clutch member 208 and a threaded cylindrical drive head 192. The threaded cylindrical drive head 192 has an upper end 200 opposite a lower end 202. Preferably, the lower end 202 is threaded, and the upper end 200 is fixed to a substantially cylindrical driving body 204 having a radial outer wall 206 defining a plurality of nodules 207 adapted to engage a plurality of rollers 212 respectively disposed between a plurality of angularly equidistant posts 210 of the sprag clutch member 208. As seen in FIGS. 21 and 22, the sprag clutch member 208 includes the plurality of angularly equidistant posts 210, a cam switch 190, and the plurality of rollers 212. The plurality of rollers 212 are located and confined between the angularly equidistant posts 210 of the sprag clutch member 208, the radial outer wall 206 of the substantially cylindrical driving body 204, and the inside surface 196 of the inner cavity 138 of the handle body 102. The sprag clutch member 208 is fixed to the inside surface 196 of the inner cavity 138 of the handle body 102, such that a rotation of the handle body 102 imparts rotational movement to the sprag clutch member 208. Preferably adjacent first and second positioning holes are formed in a top surface of the substantially cylindrical driving body 204 and a plurality of spring-loaded ball bearings 214 are located within a well defined by a bottom surface 216 of the sprag clutch member 208. The spring-loaded ball bearings 214 are each biased by a respective coiled spring 218 to engage a selected one of the first and second positioning holes. The cam switch 190 is adapted to engage a top surface 217 of the sprag clutch member 208 and the top surface of the substantially cylindrical driving body 204, such that the spring loaded ball bearings 214 can be switched between the first and second positioning holes, at the option of the user. The mechanisms and inner workings of the gearless ratchet assembly 198 will be readily apparent to a person of ordinary skill in the art in light of the present disclosure.

In such embodiment, the cylindrical chuck body 106 comprises a three-jaw chuck 162 having jaws 116 axially moveable to a constricted orientation adapted to grasp a stem shaft 118 having varying diameters and axially moveable to an extended orientation adapted to release the stem shaft 118, as illustrated in FIGS. 7 and 20. In such embodiment, rotation of the handle body 102 relative to the outer sleeve 108 will radially constrict and extend the jaws 116 for grasping and releasing the stem shaft 118 respectively. In one aspect, as can be seen, the axially movable jaws 116 provide for a ratchet assembly socket of varying size where the socket is adapted to grasp a multitude of shaft objects, at the option of the user. For example, from the disclosure herein, one skilled in the art would understand that the shaft handle 100 can be used to grasp the shaft of a broken or stripped screw or lag bolt, thereby allowing the user to rotate such screw or lag bolt in a ratcheting manner.

In another embodiment, the cylindrical chuck body 106 comprises a four jaw independent chuck having jaws 116 axially moveable to a constricted orientation adapted to grasp a stem shaft 118 having varying diameters and axially moveable to an extended orientation adapted to release the stem shaft 118. In such embodiment, rotation of the handle body 102 relative to the outer sleeve 108 will radially constrict and extend the jaws 116 for grasping and releasing the stem shaft 118 respectively.

In yet another embodiment, as shown in FIG. 14, the cylindrical chuck body 106 comprises a drill chuck 164.

In one embodiment, as illustrated in FIG. 20, the cylindrical chuck body 106 comprises a plurality of jaws 116 axially moveable to a constricted orientation adapted to grasp a stem shaft 118 having varying diameters and axially moveable to an extended orientation adapted to release the stem shaft 118. In such embodiment, rotation of the handle body 102 relative to the outer sleeve 108 will radially constrict and extend the plurality of jaws 116 for grasping and releasing the stem shaft 118 respectively. It will be apparent to those skilled in the art that the stem shaft handle 100 can be utilized, for example, to grasp a shaft of a screw or a lag bolt with a stripped or broken head.

In another embodiment, as shown in FIG. 15, the jaws 116 have teeth 166 formed on the inner surface 132 of the jaws 116.

In one embodiment, as illustrated in FIG. 9, the handle body 102 is molded in the shape of a football helmet 140.

In another embodiment, as illustrated in FIG. 10, the handle body 102 is molded in the shape of a frog 142.

In yet another embodiment, the handle body 102 is molded in the shape of a gecko.

In another embodiment, the handle body 102 is molded in the shape of a vehicle emblem, such as a Chevrolet® symbol. Upon reviewing the disclosure herein, it will be apparent to those skilled in the art that the handle body 102 of the stem shaft handle 100 can be formed as variety of different designs such as animals, characters, shapes, or symbols.

Except as may be expressly otherwise indicated, the article “a” or “an” if and as used herein is not intended to limit, and should not be construed as limiting, the description or a claim to a single element to which the article refers. Rather, the article “a” or “an” if and as used herein is intended to cover one or more such elements, unless the text expressly indicates otherwise.

This invention is susceptible to considerable variation within the spirit and scope of the appended claims.

The claimed invention is:

1. A stem shaft handle comprising:
a handle body adapted to be grasped by a hand of a user, said handle body defining an inner cavity;
a geared ratchet assembly disposed within the inner cavity of the handle body, said geared ratchet assembly comprising
a rotatable cylindrical anvil having an external surface comprising teeth,
at least one pawl for operatively engaging said teeth,
at least one pawl biasing member for biasing the at least one pawl, and
a cam switch adapted to disengage said at least one pawl from said teeth at the option of the user; and
a chuck assembly fixedly connected to the geared ratchet assembly, said chuck assembly comprising a cylindrical chuck body concentrically disposed within an outer sleeve, said cylindrical chuck body having an upper end fixedly connected to the geared ratchet assembly and having an outer surface which closely aligns with the outer sleeve in a key-and-lock style geometric alignment;
said outer surface of the cylindrical chuck body having at least one biasing locking protuberance, said outer sleeve comprising at least one nodule geometrically configured to operatively engage the at least one biasing locking protuberance in a locking arrangement, such that upon rotation of the handle body relative to the outer sleeve, at least a portion of the outer sleeve impinges the at least one biasing locking protuberance of the cylindrical chuck body until said biasing locking protuberance snaps into the locking arrangement between the outer sleeve and the cylindrical chuck body.

2. The stem shaft handle of claim 1, wherein said geared ratchet assembly further comprising a threaded cylindrical drive head wherein the cylindrical chuck body defines a central threaded opening adapted to receive the threaded cylindrical drive head, said threaded cylindrical drive head connecting the geared ratchet assembly to the chuck assembly.

3. The stem shaft handle of claim 1, wherein said upper end of the cylindrical chuck body comprises a concentrically disposed cylindrical plate, wherein the cylindrical anvil of the geared ratchet assembly is concentrically molded upon a top surface of the concentrically disposed cylindrical plate.

4. The stem shaft handle of claim 1, wherein when the at least one pawl operatively engages said teeth in a first position said at least one pawl restricts movement of the geared ratchet assembly in a counterclockwise direction.

5. The stem shaft handle of claim 1, wherein when the at least one pawl operatively engages said teeth in a second position said at least one pawl restricts movement of the geared ratchet assembly in a counterclockwise direction and a counterclockwise direction, locking movement of the handle body relative to the chuck assembly.

6. The stem shaft handle of claim 1, wherein when the at least one pawl operatively engages said teeth in a third position said at least one pawl restricts movement of the geared ratchet assembly in a clockwise direction.

7. The stem shaft handle of claim 1, wherein the cylindrical chuck body comprises a three-jaw chuck comprising jaws axially moveable to a constricted orientation adapted to grasp a stem shaft having varying diameters and axially moveable to an extended orientation adapted to release the stem shaft, whereby rotation of the handle body relative to the outer sleeve will radially constrict and extend the jaws for grasping and releasing the stem shaft respectively.

8. The stem shaft handle of claim 1, wherein the cylindrical chuck body comprises a four-jaw independent chuck comprising jaws axially moveable to a constricted orientation adapted to grasp a stem shaft having varying diameters and axially moveable to an extended orientation adapted to release the stem shaft, whereby rotation of the handle body relative to the outer sleeve will radially constrict and extend the jaws for grasping and releasing the stem shaft respectively.

9. The stem shaft handle of claim 1, wherein the cylindrical chuck body comprises a drill chuck.

10. The stem shaft handle of claim 1, wherein said cylindrical chuck body comprises a plurality of jaws axially moveable to a constricted orientation adapted to grasp a stem shaft having varying diameters and axially moveable to an extended orientation adapted to release the stem shaft, whereby rotation of the handle body relative to the outer sleeve will radially constrict and extend the jaws for grasping and releasing the stem shaft respectively.

11. The stem shaft handle of claim 1, wherein the jaws comprise teeth formed on an inner surface of the jaws.

12. The stem shaft handle of claim 1, wherein the handle body is molded in the shape of a football helmet.

13. The stem shaft handle of claim 1, wherein the handle body is molded in the shape of a frog.

14. The stem shaft handle of claim 1, wherein the handle body is molded in the shape of a gecko.

15. The stem shaft handle of claim 1, wherein the handle body is molded in the shape of a vehicle emblem.
